(19) United States
(12) Patent Application Publication
(10) Pub. No.: US 2026/0231176 A1
(43) Pub. Date: Aug. 6, 2026

(54) CROSS-LINK INTERFERENCE MEASUREMENTS WITH QUASI-CO-LOCATION TYPE D

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 19/296,255

(22) Filed: Aug. 11, 2025

Related U.S. Application Data
(60) Provisional application No. 63/755,139, filed on Feb. 6, 2025.

(51) Int. Cl. H04W 72/232; H04W 72/25

(52) U.S. Cl. CPC H04W 72/232; H04W 72/25

(57) ABSTRACT

Various aspects of the present disclosure generally relate to wireless communication. A user equipment (UE) may receive a downlink communication triggering an aperiodic cross-link interference (CLI) measurement in accordance with a quasi-co-location (QCL) Type-D configuration. The UE may perform the aperiodic CLI measurement using one or more reference signals received in accordance with the downlink communication. For example, the UE may perform the aperiodic CLI measurement using the default receive beam. The UE may report the results of the aperiodic CLI measurement in an aperiodic CLI report.

### CROSS-REFERENCE TO RELATED APPLICATION

This Patent Application claims priority to U.S. Provisional Patent Application No. 63/755,139, filed on February 6, 2025, entitled “CROSS-LINK INTERFERENCE MEASUREMENTS WITH QUASI-CO-LOCATION TYPE D,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with cross-link interference measurements with quasi-co-location type D.

### BACKGROUND

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, or radio frequency (RF) sensing, among other examples.

Subband full-duplex (SBFD) may allow at least a first user equipment (UE) and a second UE to simultaneously transmit uplink communications and receive downlink communications on different frequency resources. If the UEs are near each other, then inter-UE cross-link interference (CLI) may occur (for example, a UE may transmit an uplink communication that interferes with a neighboring UE). Accordingly, a UE may measure and report CLI. However, in some examples, a UE may receive a scheduling indication of an aperiodic CLI measurement with too little time to switch from a beam used to receive the downlink communications (for example, a quasi-co-location type D beam) to a beam used to take the aperiodic CLI measurement. In such examples, the UE may be unable to perform the aperiodic CLI measurement.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a quasi-co-location (QCL) configuration that associates one or more transmission configuration indicator (TCI) states with a QCL type D. At least one processor of the one or more processors may be configured to cause the UE to receive a physical downlink control channel (PDCCH) communication carrying downlink control information (DCI) associated with one or more aperiodic UE-to-UE cross-link interference (CLI) measurement resources corresponding to the one or more TCI states. At least one processor of the one or more processors may be configured to cause the UE to receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold. At least one processor of the one or more processors may be configured to cause the UE to transmit an aperiodic CLI report in accordance with the one or more CLI measurement signals.

Some aspects described herein relate to a method of wireless communication performed at a UE. The method may include receiving a QCL configuration that associates one or more TCI states with a QCL type D. The method may include receiving a receiving a PDCCH communication carrying DCI associated with one or more aperiodic UE-to-UE CLI measurement resources corresponding to the one or more TCI states. The method may include receiving one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold. The method may include transmitting an aperiodic CLI report in accordance with the one or more CLI measurement signals.

Some aspects described herein relate to an apparatus for wireless communication. The apparatus may include means for receiving a QCL configuration that associates one or more TCI states with a QCL type D. The apparatus may include means for receiving a PDCCH communication carrying DCI associated with one or more aperiodic apparatus-to-apparatus CLI measurement resources corresponding to the one or more TCI states. The apparatus may include means for receiving one or more CLI measurement signals in accordance with a scheduling offset between a last symbol of the PDCCH communication carrying the DCI and a first symbol of the one or more aperiodic apparatus-to-apparatus CLI measurement resources satisfying, or not satisfying, an apparatus-reported beam switch timing threshold. The apparatus may include means for transmitting an aperiodic CLI report in accordance with the one or more CLI measurement signals.

Some aspects described herein relate to a non-transitory computer-readable medium storing a set of instructions for wireless communication. The set of instructions may include one or more instructions that, when executed at a UE, may cause the UE to receive a QCL configuration that associates one or more TCI states with a QCL type D. The set of instructions may include one or more instructions that, when executed at the UE, may cause the UE to receive a PDCCH communication carrying DCI associated with one or more aperiodic UE-to-UE CLI measurement resources corresponding to the one or more TCI states. The set of instructions may include one or more instructions that, when executed at the UE, may cause the UE to receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold. The set of instructions may include one or more instructions that, when executed at the UE, may cause the UE to transmit an aperiodic CLI report in accordance with the one or more CLI measurement signals.

Aspects of the present disclosure may generally be implemented by or as a method, apparatus, system, computer program product, non-transitory computer-readable medium, user equipment, base station, network node, network entity, wireless communication device, or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating examples of full-duplex communication in a wireless network.

FIG. 3 is a diagram illustrating examples associated with subband full duplex operation at a network node.

FIG. 4 is a diagram illustrating examples of cross-link interference.

FIG. 5 is a diagram illustrating an example associated with signaling for default beams for cross-link interference (CLI) measurements with quasi-co-location (QCL) type D.

FIG. 6 is a flowchart illustrating an example process performed, for example, at a user equipment (UE) or an apparatus of a UE that supports default beams for CLI measurements with QCL type D.

FIG. 7 is a diagram of an example apparatus for wireless communication that supports default beams for CLI measurements with QCL type D.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures or functionalities in addition to or other than the structures or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In subband full-duplex (SBFD) systems, a network node may simultaneously receive uplink communications and transmit downlink communications on different frequency resources. For example, a user equipment (UE) may transmit an uplink signal in an uplink subband in a downlink-only slot or a flexible slot. As a result, SBFD operation may increase an uplink duty cycle, improve uplink coverage, and reduce latency. However, SBFD operation may allow messages to be transmitted on nearby links at the same time, which may give rise to cross-link interference (CLI). For SBFD communications, CLI may include inter-subband (inter-SB) CLI between subbands, intra-cell CLI within a cell, inter-cell CLI between different cells, or inter-UE CLI between UEs. CLI may also include inter-gNB CLI between network nodes (for example, gNBs).

A UE may use a CLI measurement resource to measure CLI. The CLI measurement resource may include one or more of a time resource, a frequency resource, or a beam, among other examples. For example, the CLI measurement resource may be a sounding reference signal (SRS) reference signal received power (RSRP) for RSRP measurements of CLI, or a CLI received signal strength indicator (RSSI) for RSSI measurements of CLI, among other examples. The UE may take CLI measurements using the CLI measurement resource and generate a CLI report that indicates the CLI measurements. The UE may transmit the CLI report (for example, in a channel state information (CSI) report) to a network node. In some examples, both the CLI measurement resources and the CLI reporting may be aperiodic.

The network node may transmit a downlink message on a transmit beam to a UE, and the UE may receive the downlink message on a receive beam quasi-co-located with the transmit beam. In some examples, the UE may expect to use the same receive beam to measure CLI. The receive beam may be a QCL Type-D beam corresponding to a QCL Type-D assumption that involves a spatial receive parameter or beamforming properties of a downlink receive signal. The QCL Type-D assumption may indicate a beam associated with information for a QCL Type-D relationship between two beams.

In some examples, QCL Type-D may be configured for aperiodic CLI reporting using aperiodic CLI measurement resources. However, a scheduling offset between a downlink communication triggering a CLI measurement and the aperiodic CLI measurement resources may be less than a UE-reported threshold beamSwitchTiming. The UE-reported threshold beamSwitchTiming may indicate a maximum length of time for the UE to perform a beam switch. As a result, in some examples, the UE may not have adequate time to switch to a receive beam indicated by the downlink communication to perform an aperiodic CLI measurement.

Various aspects relate generally to providing the UE with adequate time to switch to a receive beam for CLI measurements. Some aspects more specifically relate to using a default receive beam to which the UE has adequate time to switch. In some aspects, the UE may receive a downlink communication triggering an aperiodic CLI measurement in accordance with a QCL Type-D configuration. The UE may perform the aperiodic CLI measurement using the default receive beam (for example, the UE may monitor for one or more CLI measurement signals via the default receive beam). The UE may report the results of the aperiodic CLI measurement in an aperiodic CLI report.

In some aspects, a scheduling offset between the downlink communication triggering the aperiodic CLI measurement and one or more aperiodic CLI measurement resources may be greater than or equal to the UE-reported threshold beamSwitchTiming. For example, the UE may not expect to be configured using a scheduling offset that is less than the UE-reported threshold beamSwitchTiming. As a result, the default receive beam for measuring CLI may be configured in accordance with the QCL Type-D configuration (for example, the default receive beam may be indicated by the triggering downlink communication).

In some aspects, the scheduling offset between a downlink communication triggering a CLI measurement and the aperiodic CLI measurement resources may be less than the UE-reported threshold beamSwitchTiming, such that the UE may not have adequate time to perform a beam switch in accordance with the triggering downlink communication. For example, the default receive beam may be a latest beam associated with downlink channel reception or control resource set (CORESET) monitoring or associated with a downlink or joint TCI state, among other examples. In some examples, the default receive beam may depend on whether the UE is in a single transmission reception point (TRP) scenario or a multi-TRP (mTRP) scenario.

Particular aspects of the subject matter described in this disclosure can be implemented to realize one or more of the following potential advantages. In some examples, the described techniques can be used to ensure that the UE has adequate time to perform beam switching for aperiodic CLI measurements associated with QCL Type-D. For example, the default receive beam may be a beam that the UE has adequate time to switch to before the aperiodic CLI measurements are to occur.

The scheduling offset being greater than or equal to the UE-reported threshold beamSwitchTiming may help to reduce processing or memory resources at the UE. For example, the UE may avoid storing or executing one or more additional default receive beam rules.

The scheduling offset being less than the UE-reported threshold beamSwitchTiming may help to improve scheduling flexibility. For example, the downlink communication triggering the CLI measurement may not be constrained to times greater than or equal to the UE-reported threshold beamSwitchTiming.

As described above, wireless communication systems may be deployed to provide various services, which may involve carrying or supporting voice, text, other messaging, video, data, or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies or support one or more of the foregoing use cases or new use cases.

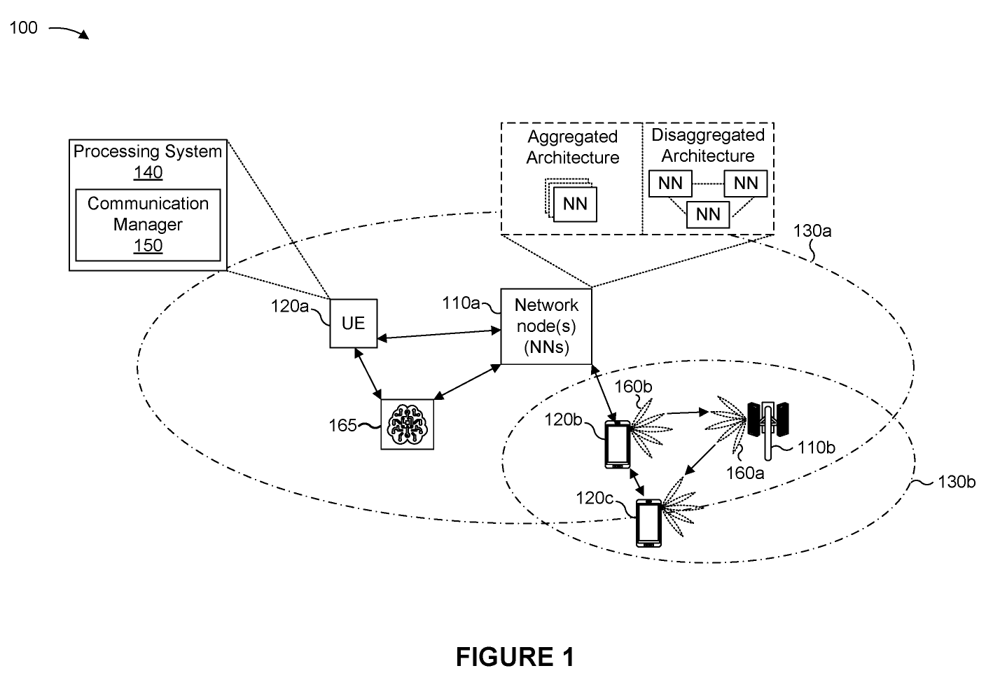

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, or that are included in mid-band frequencies. Similarly, the term “millimeter wave,” if used herein, may broadly refer to mid-band frequencies or to frequencies that are within FR2, FR4, FR4-a or FR4-1, FR5, or the EHF band. Higher frequency bands may extend 5G NR operation, 6G operation, or other RATs beyond 52.6 GHz.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120. A processing system (for example, the processing system 140) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 may include or be coupled with one or more modems (such as a cellular (for example, a 5G or 6G compliant) modem). In some examples, one or more processors of the processing system 140 include or implement one or more of the modems. The processing system 140 may also include or be coupled with multiple radios (collectively “the radio”), multiple RF chains, or multiple transceivers, each of which may in turn be coupled with one or more of multiple antennas. In some examples, one or more processors of the processing system 140 include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 of the UE 120).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a TRP, a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, or disaggregated network nodes, among other examples. Various different types of network nodes 110 may generally transmit at different power levels, serve different coverage areas (for example, a cell 130a and a cell 130b), or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, or any other suitable device or function that may communicate via a wireless medium.

Some UEs 120 may be classified according to different categories in association with different complexities or different capabilities. UEs 120 in a first category may facilitate massive IoT in the wireless communication network 100, and may offer low complexity or cost relative to UEs 120 in a second category. UEs 120 in a second category may include mission-critical IoT devices, legacy UEs, baseline UEs, high-tier UEs, advanced UEs, full-capability UEs, or premium UEs that are capable of URLLC, eMBB, or precise positioning in the wireless communication network 100, among other examples. A third category of UEs 120 may have mid-tier complexity or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, or an NR-Lite UE, among other examples. RedCap UEs may bridge a gap between the capability and complexity of NB-IoT devices or eMTC UEs, and mission-critical IoT devices or premium UEs. RedCap UEs may include, for example, wearable devices, IoT devices, industrial sensors, or cameras that are associated with a limited bandwidth, power capacity, or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), a synchronization signal or PBCH (SS/PBCH) resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 may receive uplink signals or downlink signals, respectively, via one or more antennas. The network node 110 or the UE 120 (for example, using the processing system 140 or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 140 or a coupled decoder or one or more modems) may decode the received information (such as by using an error correction code (ECC), a decoding operation, or a forward error correction (FEC) operation) to detect errors or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 or UE 120 may communicate using massive MIMO, multi-user MIMO, or single-user MIMO, which may involve rapid switching between beams or cells. For example, the amplitudes or phases of signals transmitted via antenna elements or sub-elements may be modulated and shifted relative to each other (such as by manipulating a phase shift, a phase offset, or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, or a vertical direction), a set of parameters that indicate one or more aspects of a directional signal, a direction associated with the signal, or a set of directional resources associated with the signal, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, or one or more servers, or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110, one or more servers, or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive a QCL configuration that associates one or more TCI states with a QCL type D; receive a PDCCH communication carrying DCI associated with one or more aperiodic UE-to-UE CLI measurement resources corresponding to the one or more TCI states; receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold; and transmit an aperiodic CLI report in accordance with the one or more CLI measurement signals. Additionally or alternatively, the communication manager 150 may perform one or more other operations described herein.

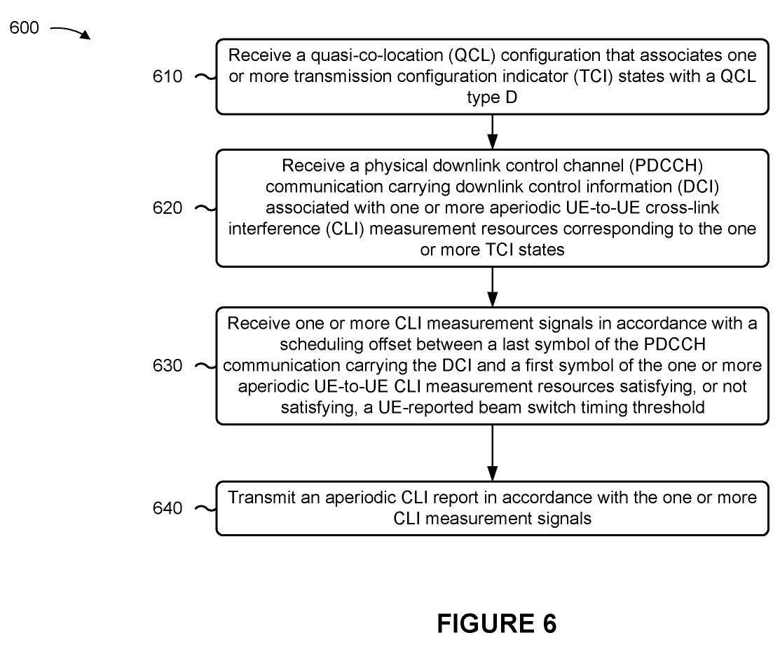

The network node 110, the UE 120, the processing system 140 of the UE 120, a CU, a DU, an RU, or any other component(s) of FIG. 1 may implement one or more techniques or perform one or more operations associated with default beams for CLI measurements with QCL type D, as described in more detail elsewhere herein. For example, the processing system 140 of the UE 120, a CU, a DU, or an RU may perform or direct operations of, for example, process 600 of FIG. 6 or other processes as described herein (alone or in conjunction with one or more other processors). Memory of the network node 110 may store data and program code (or instructions) for the network node 110, a CU, a DU, an RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 140) of the network node 110, the UE 120, a CU, a DU, or an RU, may cause the one or more processors to perform process 600 of FIG. 6 or other processes as described herein. In some examples, executing instructions may include running the instructions, converting the instructions, compiling the instructions, or interpreting the instructions, among other examples.

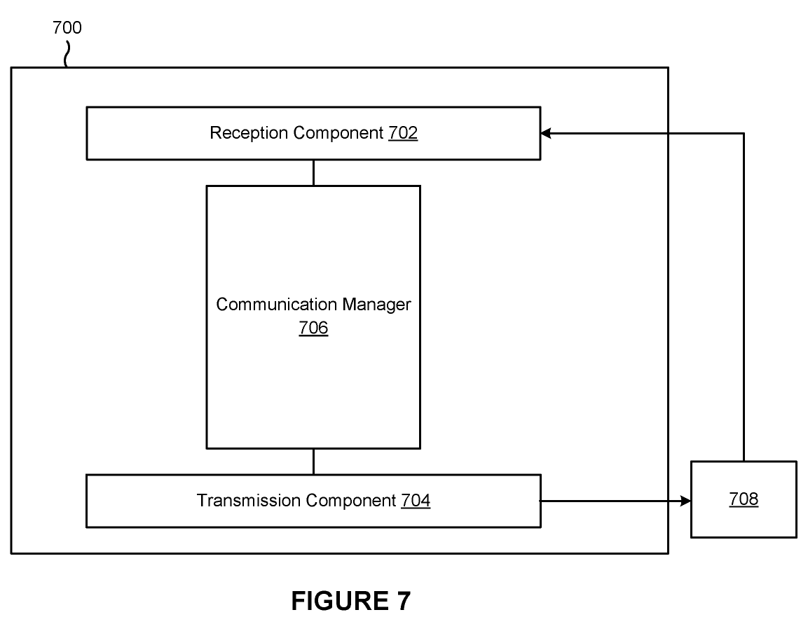

In some aspects, the UE 120 includes means for receiving a QCL configuration that associates one or more TCI states with a QCL type D; means for receiving a PDCCH communication carrying DCI associated with one or more aperiodic UE-to-UE CLI measurement resources corresponding to the one or more TCI states; means for receiving one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold; or means for transmitting an aperiodic CLI report in accordance with the one or more CLI measurement signals. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

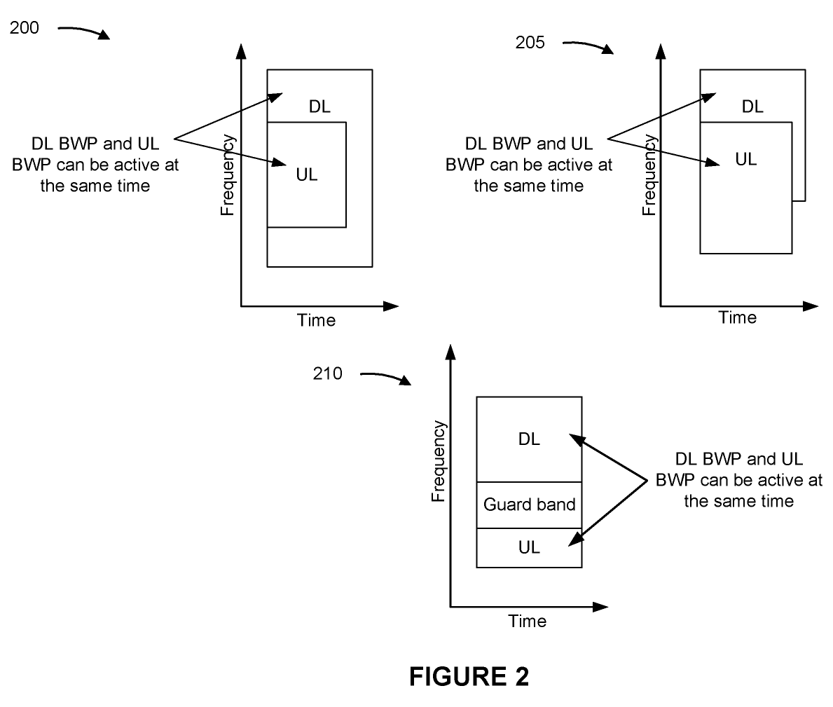

FIG. 2 is a diagram illustrating examples 200, 205, and 210 of full-duplex communication in a wireless network. “Full-duplex communication” in a wireless network refers to simultaneous bi-directional communication between devices in the wireless network. For example, a network node 110 operating in a full-duplex mode may transmit an uplink communication and receive a downlink communication at the same time (for example, in the same slot or the same symbol). “Half-duplex communication” in a wireless network refers to unidirectional communications (for example, only downlink communication or only uplink communication) between devices at a given time (for example, in a given slot or a given symbol).

As shown in FIG. 2, examples 200 and 205 show examples of in-band full-duplex (IBFD) communication. In IBFD, a network node 110 may receive an uplink communication from a UE 120 and transmit a downlink communication to a UE 120 on the same time and frequency resources. As shown in example 200, in a first example of IBFD, the time and frequency resources for uplink communication may fully overlap with the time and frequency resources for downlink communication. As shown in example 205, in a second example of IBFD, the time and frequency resources for uplink communication may partially overlap with the time and frequency resources for downlink communication.

As further shown in FIG. 2, example 210 shows an example of SBFD communication, which may also be referred to as “sub-band frequency division duplex” or “flexible duplex.” In SBFD, a network node 110 may receive an uplink communication from a UE 120 and transmit a downlink communication to a UE 120 at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

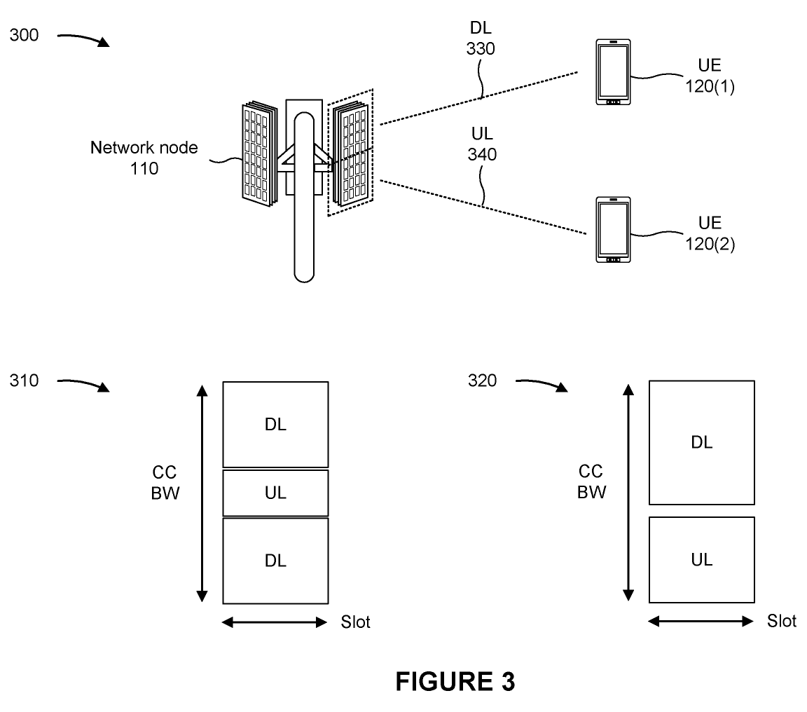

FIG. 3 is a diagram illustrating examples 300, 310, and 320 associated with SBFD operation at a network node 110, in accordance with the present disclosure.

In example 300, the network node 110 may operate in a full duplex mode (for example, an SBFD mode) to simultaneously transmit a downlink signal 330 (“DL”) to the UE 120(1) and receive an uplink signal 340 (“UL”) from the UE 120(2) on a sub-band basis on the same slot. For example, the network node 110 may communicate in SBFD mode with UEs 120(1) and 120(2) using a time division duplex (TDD) carrier, or the communication may be intra-band-carrier-aggregation-based. In example 310, two downlink sub-bands and one uplink sub-band may be configured for operation in SBFD mode. Additionally or alternatively, in example 320, one downlink sub-band and one uplink sub-band may be configured for operation in SBFD mode.

SBFD may increase uplink duty cycles, which may lead to latency reduction and uplink coverage improvement. For example, SBFD may enable uplink latency savings by allowing the network node 110 to transmit uplink signals in uplink sub-bands configured in downlink-only slots or flexible slots. Additionally or alternatively, SBFD may enhance one or more of system capacity, resource utilization, or spectrum efficiency. Additionally or alternatively, SBFD may enable flexible and dynamic uplink or downlink resource adaptation in a robust manner according to uplink or downlink traffic.

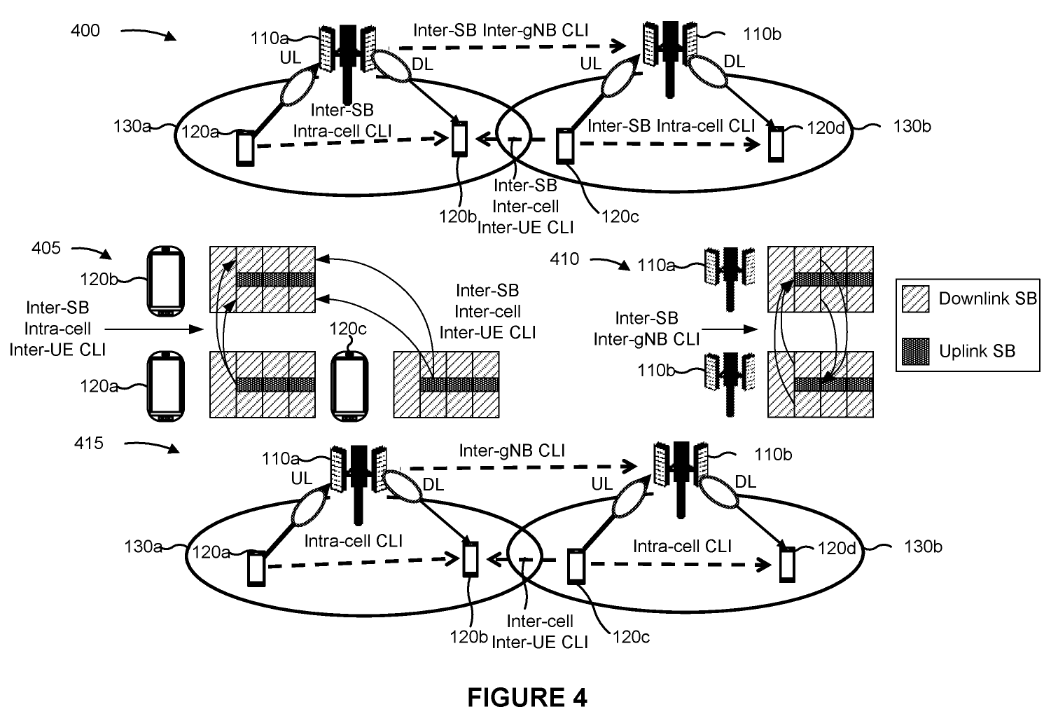

FIG. 4 is a diagram illustrating examples 400, 405, 410, and 415 of CLI, in accordance with the present disclosure.

In SBFD, messages can be transmitted on nearby links at the same time, which can cause CLI. Example 400 shows different types of CLI for SBFD communications, such as inter-SB CLI between subbands, intra-cell CLI within a cell, inter-cell CLI between cells (for example, cells 130a and 130b), inter-UE CLI between UEs (for example, UEs 120a-120d), and inter-gNB CLI between network nodes 110a and 110b. Example 405 shows how inter-SB inter-UE CLI can arise. For example, inter-SB intra-cell inter-UE CLI may occur when the UE 120a transmits an uplink communication in an uplink subband that interferes with the UE 120b via one or more downlink subbands. Additionally or alternatively, inter-SB inter-cell inter-UE CLI may occur when the UE 120c transmits an uplink communication in an uplink subband that interferes with the UE 120b via one or more downlink subbands. Example 410 shows how inter-SB inter-gNB CLI can arise. For example, inter-SB inter-gNB CLI may occur when the network node 110a transmits a downlink communication in one or more downlink subbands that interferes with the network node 110b via an uplink subband. Additionally or alternatively, inter-SB inter-gNB CLI may occur when the network node 110b transmits a downlink communication in one or more downlink subbands that interferes with the network node 110a via an uplink subband. Example 415 shows different types of CLI for partially or fully overlapped full duplex communications, such as intra-cell CLI within a cell, inter-cell CLI between cells (for example, cells 130a and 130b), inter-UE CLI between UEs (for example, UEs 120a-120d), and inter-gNB CLI between network nodes 110a and 110b.

A CLI framework may support L1-based UE-to-UE (for example, inter-UE) CLI measurement and reporting. For example, the UE 120b may use a CLI measurement resource for measuring CLI. In some examples, the CLI measurement resource may be periodic, semi-persistent, or aperiodic. In some examples, the CLI measurement resource may be an SRS-RSRP measurement resource for RSRP measurements of CLI or a CLI-RSSI measurement resource for RSSI measurements of CLI. In some examples, the UE 120b may be configured with one or more QCL type D (also referred to as “‘typeD’ QCL,” “QCL type-D,” or “QCL Type-D,” among other examples) assumptions for the CLI measurement resource. QCL type D may involve a spatial receive parameter or beamforming properties of a downlink receive signal. A QCL type-D assumption may include information for a QCL type-D relationship between two beams. In some examples, measurement reporting may be periodic, semi-persistent, or aperiodic.

An information element (IE) CSI-AperiodicTriggerStateList may support aperiodic L1 CLI-RSSI/CLI-SRS-RSRP reporting on PUSCH. In a parameter CSI-AssociatedReportConfigInfo, a list of TCI state(s) with qcl-Type set to ‘typeD’ may be configured. The TCI state(s) may correspond to the resource(s) in a set of CLI measurement resources (for example, periodic, semi-persistent, or aperiodic CLI measurement resources) indicated by CSI-AssociatedReportConfigInfo. In some examples, the list of TCI states may be configured if a parameter unifiedTCI-StateType is configured and the CLI measurement resource(s) are aperiodic. If the list of TCI states is not configured (for example, is absent), then the UE 120b may assume the following for each CLI measurement resource: if the parameter unifiedTCI-StateType is not configured, then, for purposes of performing CLI measurement in FR2, the UE 120b may assume that the configured CLI measurement resources are quasi-co-located with typeD to one of the latest received PDSCH beam or a latest monitored CORESET beam; and if the parameter unifiedTCI-StateType is configured, then the UE 120b may use a QCL type-D assumption that follows QCL information in an indicated downlink-only or joint TCI state.

For aperiodic L1 CLI-RSSI/CLI-SRS-RSRP reporting on PUSCH using a set of periodic CLI measurement resources, the TCI state(s) with QCL typeD for the CLI measurement resources in the periodic CLI measurement resource set may be configured per CLI measurement resource (for example, either for all resources in the set or for none) by a higher-layer parameter. For each periodic CLI measurement resource, this higher-layer parameter may provide a reference to one TCI statein the list of TCI states (for example, one “TCI-State” in “TCI-States”) for providing the QCL source and QCL typeD. If the TCI state is not configured, then the UE QCL assumptions may be default rules. Additionally or alternatively, for aperiodic L1 CLI-RSSI/CLI-SRS-RSRP reporting on PUSCH using a set of semi-persistent CLI measurement resources, the network node 110 may activate or deactivate the configured semi-persistent CLI measurement resource sets by transmitting a semi-persistent CLI measurement resource set activation/deactivation MAC-CE. This MAC-CE may include a TCI state identifier i (IDᵢ) field (where i denotes a CLI measurement resource), which may be used as a typeD QCL source for the CLI measurement resource within the semi-persistent CLI measurement resource set. In some examples, either all TCI state identifier (ID) fields may be present or none may be present. If the TCI state ID field(s) are absent, then the UE QCL assumptions may be default rules.

Thus, QCL typeD may be configured for aperiodic L1 CLI-RSSI/CLI-SRS-RSRP reporting on PUSCH in accordance with aperiodic CLI measurement resources, periodic CLI measurement resources, or semi-persistent CLI measurement resources. In some examples, a scheduling offset between a last symbol of a PDCCH carrying triggering DCI and a first symbol of one or more aperiodic CLI measurement resources (for example, CLI SRS-RSRP or CLI-RSSI resources) may be less than a UE-reported threshold beamSwitchTiming. The threshold beamSwitchTiming may indicate a maximum length of time that the UE 120 can use to decode DCI or switch beams. As a result, in some examples, the UE 120 may not have adequate time to switch to a beam to perform an aperiodic CLI measurement in accordance with the PDCCH.

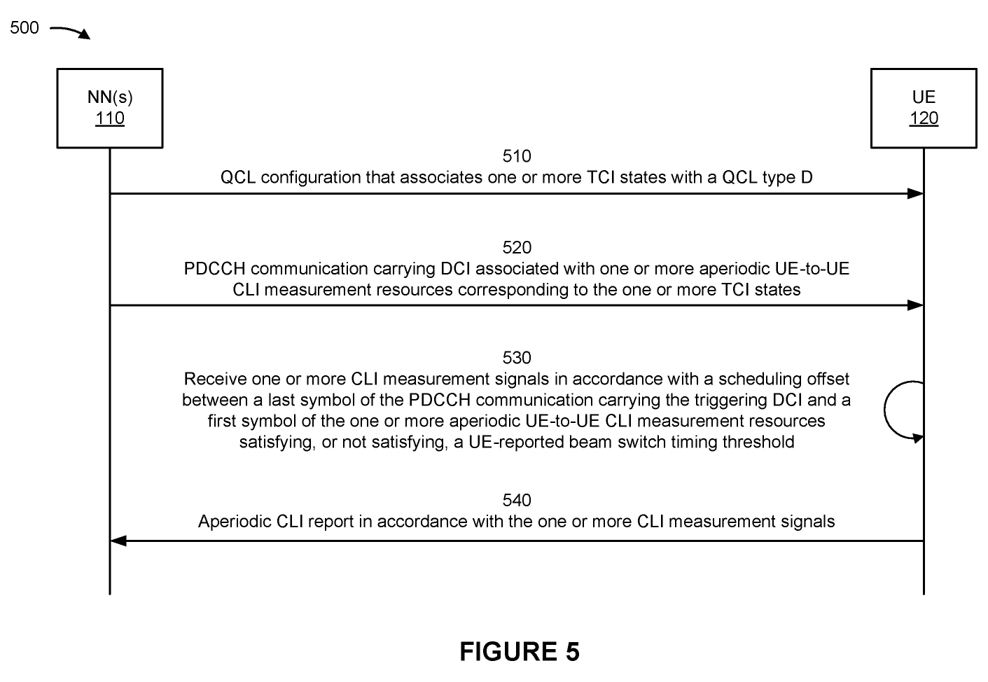

FIG. 5 is a diagram illustrating an example 500 associated with signaling for CLI measurements with QCL type D. As shown in FIG. 5, a network node 110 and a UE 120 may communicate with one another.

In a first operation 510, the network node 110 may transmit, and the UE 120 may receive, a QCL configuration that associates one or more TCI states with a QCL type D. The QCL configuration may indicate one or more QCL reference signal sources or QCL types (which may include only type D). The QCL reference signal source(s) may include a network-side SSB beam or CSI-RS beam. In some examples, the one or more TCI states (for example, a list of TCI states) may be configured.

In some aspects, the UE 120 may receive a QCL configuration for each aperiodic UE-to-UE CLI measurement resource in a UE-to-UE CLI measurement resource set associated with one or more triggering states, the QCL configuration may configure one or more QCL reference signal sources and QCL type D via QCL higher-layer signaling of QCL information that includes one or more TCI states corresponding to each aperiodic UE-to-UE CLI measurement resource, a TCI state of the one or more TCI states corresponding to each aperiodic UE-to-UE CLI measurement resource may be configured with a reference to a QCL reference signal configured with a QCL type set to QCL type D, and the QCL reference signal may be a SS/PBCH or a periodic or semi-persistent UE-to-UE CLI measurement resource. For example, the UE 120 may receive the QCL configuration for each aperiodic CLI measurement resource (for example, a CLI SRS-RSRP or CLI-RSSI resource) in a CLI measurement resource set (for example, a CLI SRS-RSRP or CLI-RSSI resource set) associated with a CSI triggering state. The CSI triggering state may be a CLI trigger state that is used to trigger a CLI measurement. In some examples, the UE 120 may receive the QCL configuration via higher-layer signaling of QCL information, which may include a list of references to the one or more TCI states for the aperiodic CLI SRS-RSRP or CLI-RSSI resources associated with the CSI triggering state. If a TCI state indicated in the list is configured with a reference to a reference signal that is configured with a QCL type set to ‘typeD,’ then the reference signal may be an SS/PBCH block located in a component carrier (CC) or downlink BWP or the reference signal may be a CLI measurement resource configured as periodic or semi-persistent. The SS/PBCH block or CLI measurement resource may be located in the same component carrier (CC) or downlink BWP as, or a different CC or downlink BWP from, a CC or downlink BWP of the aperiodic CLI resources.

In a second operation 520, the network node 110 may transmit, and the UE 120 may receive, a PDCCH communication carrying DCI (for example, triggering DCI) associated with one or more aperiodic UE-to-UE CLI measurement resources corresponding to the one or more TCI states. The DCI may prompt (or “trigger”) the UE 120 to perform an aperiodic CLI measurement. In some aspects, the one or more aperiodic UE-to-UE CLI measurement resources include one or more aperiodic UE-to-UE CLI SRS-RSRP measurement resources or CLI-RSSI measurement resources. For example, the one or more aperiodic UE-to-UE CLI measurement resources may include one or more L1 aperiodic UE-to-UE CLI SRS-RSRP measurement resources or one or more L1 CLI-RSSI measurement resources.

In a third operation 530, the UE 120 may receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold. For example, the UE 120 may receive the one or more CLI measurements using a default beam that depends at least on whether the length of time satisfies (for example, is greater than or equal to) the beam switch timing threshold (for example, the UE-reported threshold beamSwitchTiming), or does not satisfy (for example, is less than) the beam switch timing threshold.

In some aspects, the UE 120 may receive the one or more CLI measurement signals using the default beam in accordance with the scheduling offset satisfying the UE-reported beam switch timing threshold. For example, the scheduling offset between the last symbol of the PDCCH carrying triggering DCI and the first symbol of one or more aperiodic CLI measurement resources may be greater than or equal to the UE-reported threshold beamSwitchTiming. The default beam may be configured per aperiodic UE-to-UE CLI measurement resource of the one or more aperiodic UE-to-UE CLI measurement resources, which may be associated with one or more triggering states. For example, the UE 120 may use the beam that is indicated by one or more of the QCL configuration or the triggering DCI. Thus, in accordance with the rule, the UE 120 may not expect to be configured with a scheduling offset between the last symbol of the PDCCH carrying the triggering DCI and the first symbol of aperiodic CLI SRS-RSRP or CLI-RSSI resources that is smaller than the UE-reported threshold beamSwitchTiming.

In some aspects, the UE 120 may receive the one or more CLI measurement signals using the default beam in accordance with the scheduling offset not satisfying the UE-reported beam switch timing threshold. For example, the scheduling offset between the last symbol of the PDCCH carrying triggering DCI and the first symbol of one or more aperiodic CLI measurement resources may be less than the UE-reported threshold beamSwitchTiming.

In some aspects, the default beam may be identified using a rule. For example, the rule may indicate which default beam the UE 120 is to use to receive the one or more CLI measurement signals.

In some aspects (for example, where the scheduling offset does not satisfy the UE-reported beam switch timing threshold), the default beam may be, in accordance with the rule, a latest beam associated with a latest-received PDSCH reception or a latest-monitored CORESET in accordance with no unified TCI state type being configured. For example, if unifiedTCI-StateType is not configured, then, for performing CLI measurement in FR2, the UE 120 may assume that the configured CLI measurement resources are quasi-co-located with TypeD to one of the latest received PDSCH or the latest monitored CORESET.

In some aspects (for example, where the scheduling offset does not satisfy the UE-reported beam switch timing threshold), the default beam may be, in accordance with the rule, associated with an indicated downlink-only or joint TCI state in accordance with a unified TCI state type being configured. For example, if unifiedTCI-StateType is configured, then the default beam may correspond to the downlink or joint TCI state (for example, an indicated downlink only or joint TCI state).

In some aspects (for example, where the scheduling offset does not satisfy the UE-reported beam switch timing threshold), the UE 120 may be associated with a single TRP architecture. The UE 120 may be associated with the single TRP architecture in that the UE 120 may belong to the single TRP architecture (for example, a single TRP scenario). For example, the UE 120 may be configured to communicate with a single TRP.

In some aspects (for example, where the UE 120 is associated with the single TRP architecture), the default beam may be, in accordance with the rule, associated with a QCL assumption of a downlink signal scheduled in the one or more aperiodic UE-to-UE CLI measurement resources, and the downlink signal may be a PDSCH communication scheduled with a scheduling offset that satisfies a QCL time duration threshold, a periodic CSI-RS, a semi-persistent CSI-RS, an aperiodic CSI-RS in a non-zero-power CSI-RS resource set, a periodic CLI SRS-RSRP or CLI-RSSI, a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold. For example, if there is any other downlink signal with an indicated TCI state in the same symbol(s) as one or more of CLI SRS-RSRP or CLI-RSSI, then the UE 120 apply the QCL assumption of the other downlink signal upon receiving the aperiodic CLI SRS-RSRP or CLI-RSSI. The other downlink signal may be a PDSCH communication scheduled with an offset that is greater than or equal to the threshold timeDurationForQCL (for example, the QCL time duration threshold), a periodic CSI-RS, a semi-persistent CSI-RS, an aperiodic CSI-RS in a NZP-CSI-RS-ResourceSet, a periodic CLI SRS-RSRP or CLI-RSSI, a semi-persistent CLI SRS-RSRP or CLI-RSSI, or an aperiodic CLI SRS-RSRP or CLI-RSSI in a CLI SRS-RSRP or CLI-RSSI-ResourceSet scheduled with an offset greater than or equal to the UE-reported threshold beamSwitchTiming, among other examples.

In some aspects (for example, where the UE 120 is associated with the single TRP architecture), the default beam may be, in accordance with the rule, associated with a QCL assumption of a CORESET associated with a monitored search space with a lowest CORESET identifier in a latest slot in which the UE monitors one or more CORESETs within an active BWP of a serving cell of the UE in accordance with the UE not receiving an indication of a downlink or joint TCI state list and in accordance with the one or more CORESETs being configured for a BWP of the one or more CLI measurement signals. For example, if the UE 120 is not provided with a dl-OrJointTCI-StateList, and if at least one CORESET is configured for the BWP in which the aperiodic CLI SRS-RSRP or CLI-RSSI is received, then, upon receiving the aperiodic CLI SRS-RSRP or CLI-RSSI, the UE 120 may apply the QCL assumption used for the CORESET associated with a monitored search space with the lowest controlResourceSetId in the latest slot in which one or more CORESETs within the active BWP of the serving cell are monitored.

In some aspects (for example, where the UE 120 is associated with the single TRP architecture), the default beam may be, in accordance with the rule, associated with a QCL assumption of a CORESET associated with a monitored search space with a lowest CORESET identifier in a latest slot in which the UE monitors one or more CORESETs within an active BWP of a serving cell of the UE in accordance with the UE receiving an indication of a downlink or joint TCI state list, in accordance with an indicated TCI state being associated with a physical cell identifier (PCI) that does not correspond to the serving cell, and in accordance with the one or more CORESETs being configured for a BWP of the one or more CLI measurement signals. For example, if the UE 120 is provided with a dl-OrJointTCI-StateList, and if the indicated TCI state is associated with a PCI different from the serving cell, regardless of a configuration of followUnifiedTCI-State, and if at least one CORESET is configured for the BWP in which the aperiodic CLI SRS-RSRP or CLI-RSSI is received, then, upon receiving the aperiodic CLI SRS-RSRP or CLI-RSSI, then the UE 120 may apply the QCL assumption used for the CORESET associated with a monitored search space with the lowest controlResourceSetId in the latest slot in which one or more CORESETs within the active BWP of the serving cell are monitored.

In some aspects (for example, where the UE 120 is associated with the single TRP architecture), the UE 120 may be associated with carrier aggregation (CA), and the default beam may be, in accordance with the rule, associated with a QCL type D assumption of a CLI signal in a CC with a lowest CC identifier of CC identifiers of the one or more CLI measurement signals in a frequency band in accordance with the one or more CLI measurement signals having different QCL assumptions and respective CCs in a slot. For example, in a CA scenario, if the ‘QCL-TypeD’ of the aperiodic CLI SRS-RSRPs or CLI-RSSIs from respective CCs in a band are different in a slot, then the QCL-TypeD assumption of the CLI SRS-RSRP or CLI-RSSI in the CC with lowest CC ID in the band may be applied to all of the aperiodic CLI SRS-RSRPs or CLI-RSSIs in the CCs in the band.

In some aspects (for example, where the UE 120 is associated with the single TRP architecture), the default beam may be, in accordance with the rule, associated with an indicated TCI state in accordance with the UE receiving an indication of a downlink or joint TCI state list and in accordance with the indicated TCI state being associated with a PCI of a serving cell of the UE. For example, if the UE 120 is provided with dl-OrJointTCI-StateList and the indicated TCI state is associated with the PCI of the serving cell, regardless of a configuration of followUnifiedTCI-State, then the indicated TCI state may be applied to the aperiodic CLI SRS-RSRP or CLI-RSSI.

In some aspects (for example, where the scheduling offset does not satisfy the UE-reported beam switch timing threshold), the UE 120 may be associated with an mTRP architecture. The UE 120 may be associated with the mTRP architecture in that the UE 120 may belong to the mTRP architecture (for example, an mTRP scenario). For example, the UE 120 may be configured to communicate with multiple TRPs.

In some aspects (for example, where the UE 120 is associated with the mTRP architecture), default TCI states corresponding to respective CORESET pool indexes may be enabled and the respective CORESET pool indexes may be associated with respective TRPs of the mTRP architecture and may be configured with respective values in a CORESET. For example, the UE 120 may be configured with enableDefaultTCI-StatePerCoresetPoolIndex, and the UE 120 may be configured by a higher-layer parameter PDCCH-Config that includes two different values of coresetPoolIndex in ControlResourceSet.

In some aspects (for example, where default TCI states corresponding to respective CORESET pool indexes are enabled and the respective CORESET pool indexes are associated with respective TRPs of the mTRP architecture and are configured with respective values in a CORESET), the default beam may be, in accordance with the rule, associated with a QCL assumption of a downlink signal with an indicated TCI state in a same symbol as the one or more CLI measurement signals. The downlink signal may be a PDSCH communication scheduled by a PDCCH communication associated with a same CORESET pool index as the PDCCH communication carrying the DCI and having a scheduling offset that satisfies a QCL time duration threshold, or the downlink signal may be an aperiodic CLI SRS-RSRP or CLI-RSSI triggered by a PDCCH communication associated with a same CORESET pool index as the PDCCH communication carrying the DCI and having a scheduling offset that satisfies the UE-reported beam switch timing threshold and a reported value may be 14, 28, or 48. For example, if there is any other downlink signal with an indicated TCI state in the same symbol(s) as the CLI SRS-RSRP or CLI-RSSI, then the UE 120 may apply the QCL assumption of the other downlink signal upon receiving the aperiodic CLI SRS-RSRP or CLI-RSSI. The other downlink signal may be a PDSCH communication scheduled by a PDCCH communication associated with the same coresetPoolIndex as the PDCCH communication triggering the aperiodic CLI SRS-RSRP or CLI-RSSI and scheduled with an offset greater than or equal to the threshold timeDurationForQCL, or an aperiodic CLI SRS-RSRP or CLI-RSSI triggered by a PDCCH communication associated with the same coresetPoolIndex as the PDCCH communication triggering the aperiodic CLI SRS-RSRP or CLI-RSSI and scheduled with an offset greater than or equal to the UE-reported threshold beamSwitchTiming in examples where the reported value is 14, 28, or 48.

In some aspects (for example, where default TCI states corresponding to respective CORESET pool indexes are enabled and the respective CORESET pool indexes are associated with respective TRPs of the mTRP architecture and are configured with respective values in a CORESET), the default beam may be, in accordance with the rule, associated with one or more QCL parameters of a CORESET associated with a monitored search space with a lowest CORESET identifier among CORESETs configured with a same CORESET pool index value as the PDCCH communication in a latest slot in which the UE monitors one or more CORESETs associated with the same CORESET pool index as the PDCCH communication in accordance with a downlink communication not having an indicated TCI state in a same symbol as the one or more CLI measurement signals. For example, if there are no downlink signals with an indicated TCI state in the same symbols as the CLI SRS-RSRP or CLI-RSSI, then the UE 120 may apply the QCL parameter(s) of the CORESET associated with a monitored search space with the lowest controlResourceSetId among CORESETs that are configured with the same value of coresetPoolIndex as the PDCCH communication triggering the aperiodic CLI SRS-RSRP or CLI-RSSI, in the latest slot in which one or more CORESETs are associated with the same value of coresetPoolIndex as the PDCCH triggering the aperiodic CLI SRS-RSRP or CLI-RSSI.

In some aspects (for example, where the UE 120 is associated with the mTRP architecture), multiple default TCI states may be enabled and at least one TCI codepoint may be mapped to the multiple default TCI states. For example, the UE 120 may be configured with enableTwoDefaultTCI-States and at least one TCI codepoint may be mapped to two TCI states.

In some aspects (for example, where multiple default TCI states are enabled and at least one TCI codepoint is mapped to the multiple default TCI states), the default beam may be, in accordance with the rule, associated with a QCL assumption of a downlink signal with an indicated TCI state in a same symbol as the one or more CLI measurement signals. The downlink signal may be a PDSCH communication scheduled with a scheduling offset that satisfies a QCL time duration threshold, or the downlink signal may be an aperiodic CLI SRS-RSRP or CLI-RSSI scheduled with a scheduling offset that satisfies the UE-reported beam switch timing threshold and a reported value may be 14, 28, or 48. For example, if there is any other downlink signal with an indicated TCI state in the same symbol(s) as the CLI SRS-RSRP or CLI-RSSI, then the UE 120 may apply the QCL assumption of the other downlink signal upon receiving the aperiodic CLI SRS-RSRP or CLI-RSSI. The other downlink signal may be a PDSCH communication scheduled with an offset greater than or equal to the threshold timeDurationForQCL, or an aperiodic CLI SRS-RSRP or CLI-RSSI scheduled with an offset greater than or equal to the UE-reported threshold beamSwitchTiming in examples where the reported value is 14, 28, or 48.

In some aspects (for example, where multiple default TCI states are enabled and at least one TCI codepoint is mapped to the multiple default TCI states), the default beam may be, in accordance with the rule, associated with a first TCI state of the multiple default TCI states that corresponds to a lowest TCI codepoint of the at least one TCI codepoint and that is associated with a PDSCH within an active BWP of a cell in which the one or more CLI measurement signals are scheduled in accordance with a downlink communication not having an indicated TCI state in a same symbol as the one or more CLI measurement signals. For example, if there are no other downlink signals with an indicated TCI state in the same symbol(s) as the CLI SRS-RSRP or CLI-RSSI, then the UE 120 may apply the first one of two TCI states corresponding to the lowest TCI codepoint among those mapped to two TCI states and applicable to the PDSCH communication within the active BWP of the cell in which the CLI SRS-RSRP or CLI-RSSI is to be received when receiving the aperiodic CLI SRS-RSRP or CLI-RSSI.

In some aspects (for example, where the UE 120 is associated with the mTRP architecture), a single-frequency network (SFN) scheme A or an SFN scheme B may be configured, multiple default TCI states may not be configured, and multiple TCI states associated with a CORESET may be activated using an activation command. For example, the UE 120 may be configured with sfnSchemePdcch set to ‘sfnSchemeA’ or ‘sfnSchemeB,’ the UE 120 may not be configured with enableTwoDefaultTCI-States, and the two TCI states may be activated for the CORESET by the activation command.

In some aspects (for example, where the SFN scheme A or the SFN scheme B is configured, multiple default TCI states are not configured, and multiple TCI states associated with a CORESET are activated using an activation command), the default beam may be, in accordance with the rule, associated with a QCL assumption of a downlink signal with an indicated TCI state in a same symbol as the one or more CLI measurement signals. The downlink signal may be a PDSCH communication scheduled with a scheduling offset that satisfies a QCL time duration threshold, a periodic CSI-RS, a semi-persistent CSI-RS, an aperiodic CSI-RS in a non-zero-power CSI-RS resource set, a periodic CLI SRS-RSRP or CLI-RSSI, a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold and a reported value may be 14, 28, or 48. For example, if there is any other downlink signal with an indicated TCI state in the same symbols as the CLI SRS-RSRP or CLI-RSSI, then the UE 120 may apply the QCL assumption of the other downlink signal upon receiving the aperiodic CLI SRS-RSRP or CLI-RSSI. The other downlink signal may be a PDSCH communication scheduled with an offset greater than or equal to the threshold timeDurationForQCL, a periodic CSI-RS, a semi-persistent CSI-RS, an aperiodic CSI-RS in a NZP-CSI-RS-ResourceSet, a periodic CLI SRS-RSRP or CLI-RSSI, a semi-persistent CLI SRS-RSRP or CLI-RSSI, or an aperiodic CLI SRS-RSRP or CLI-RSSI in a CLI SRS-RSRP or CLI-RSSI resource set scheduled with an offset greater than or equal to the UE reported threshold beamSwitchTiming in examples where the reported value is 14, 28, or 48.

In some aspects (for example, where the default beam is associated with a QCL assumption of a downlink signal with an indicated TCI state in a same symbol as the one or more CLI measurement signals), the default beam may be, in accordance with the rule, associated with a first TCI state associated with a CORESET corresponding to a lowest CORESET identifier in a latest slot within an BWP of a cell in which the one or more CLI measurement signals are received in accordance with multiple TCI states being activated for the CORESET. For example, if there are no other downlink signals with an indicated TCI state in the same symbol(s) as the CLI SRS-RSRP or CLI-RSSI, then the UE 120 may apply the first one of TCI states indicated for the CORESET with the lowest CORESET ID in the latest slot within an active BWP of the cell in which the CLI SRS-RSRP or CLI-RSSI is to be received upon receiving the aperiodic CLI SRS-RSRP or CLI-RSSI, if two TCI states are activated for the CORESET.

In some aspects (for example, where the default beam is associated with a QCL assumption of a downlink signal with an indicated TCI state in a same symbol as the one or more CLI measurement signals), the default beam may be, in accordance with the rule, associated with a single activated TCI state of a CORESET corresponding to a lowest CORESET identifier in a latest slot within an active BWP of a cell in which the one or more CLI measurement signals are received in accordance with multiple TCI states not being activated for the CORESET. For example, if two TCI states are not activated for the CORESET, then the UE 120 may apply a single activated TCI state of the CORESET with the lowest CORESET ID in the latest slot within the active BWP of the cell in which the CLI SRS-RSRP or CLI-RSSI is to be received, upon receiving the aperiodic CLI SRS-RSRP or CLI-RSSI.

In a fourth operation 540, the UE 120 may transmit, and the network node 110 may receive, an aperiodic CLI report in accordance with the one or more CLI measurement signals. For example, the aperiodic CLI report may indicate measurement results associated with the one or more CLI measurement signals. For example, the aperiodic CLI report may indicate one or more L1 CLI-RSSI or CLI-SRS-RSRP in accordance with the one or more CLI measurement signals. In some examples, the UE 120 may transmit the aperiodic CLI report over a PUSCH.

Receiving the one or more CLI measurement signals in accordance with the scheduling offset satisfying, or not satisfying, the UE-reported beam switch timing threshold may help to ensure that the UE 120 has adequate time to perform beam switching for aperiodic CLI measurements associated with QCL Type-D. For example, the UE 120 may use a default beam to which the UE 120 has adequate time to switch to before the first symbol of the one or more aperiodic UE-to-UE CLI measurement resources.

Receiving the one or more CLI measurement signals using the default beam in accordance with the scheduling offset satisfying the UE-reported beam switch timing threshold may help to reduce processing or memory resources at the UE 120. For example, the UE 120 may avoid storing or executing one or more additional default beam rules.

Receiving the one or more CLI measurement signals using the default beam in accordance with the scheduling offset not satisfying the UE-reported beam switch timing threshold may help to improve scheduling flexibility. For example, the downlink communication triggering the CLI measurement may not be constrained to times greater than or equal to the UE-reported threshold beamSwitchTiming.

FIG. 6 is a flowchart illustrating an example process 600 performed, for example, at a UE or an apparatus of a UE that supports CLI measurements with QCL type D. Example process 600 is an example where the apparatus or the UE (for example, UE 120) performs operations associated with CLI measurements with QCL type D.

As shown in FIG. 6, in some aspects, process 600 may include receiving a QCL configuration that associates one or more TCI states with a QCL type D (block 610). For example, the UE (such as by using communication manager 150 or reception component 702, depicted in FIG. 7) may receive a QCL configuration that associates one or more TCI states with a QCL type D, as described above, such as in connection with operation 510 (FIG. 5).

As further shown in FIG. 6, in some aspects, process 600 may include receiving a PDCCH communication carrying DCI associated with one or more aperiodic UE-to-UE CLI measurement resources corresponding to the one or more TCI states (block 620). For example, the UE (such as by using communication manager 150 or reception component 702, depicted in FIG. 7) may receive a PDCCH communication carrying DCI associated with one or more aperiodic UE-to-UE CLI measurement resources corresponding to the one or more TCI states, as described above, such as in connection with operation 520 (FIG. 5).

As further shown in FIG. 6, in some aspects, process 600 may include receiving one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold (block 630). For example, the UE (such as by using communication manager 150 or reception component 702, depicted in FIG. 7) may receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold, as described above, such as in connection with operation 530 (FIG. 5).

As further shown in FIG. 6, in some aspects, process 600 may include transmitting an aperiodic CLI report in accordance with the one or more CLI measurement signals (block 640). For example, the UE (such as by using communication manager 150 or transmission component 704, depicted in FIG. 7) may transmit an aperiodic CLI report in accordance with the one or more CLI measurement signals, as described above, such as in connection with operation 540 (FIG. 5).

Process 600 may include additional aspects, such as any single aspect or any combination of aspects described below or in connection with one or more other processes described elsewhere herein.

In a first additional aspect, the one or more aperiodic UE-to-UE CLI measurement resources include one or more aperiodic UE-to-UE CLI SRS-RSRP measurement resources or CLI-RSSI measurement resources.

In a second additional aspect, alone or in combination with the first aspect, receiving the one or more CLI measurement signals includes receiving the one or more CLI measurement signals using a default beam in accordance with the scheduling offset satisfying the UE-reported beam switch timing threshold, the default beam is configured per aperiodic UE-to-UE CLI measurement resource of the one or more aperiodic UE-to-UE CLI measurement resources, and the one or more aperiodic UE-to-UE CLI measurement resources are associated with one or more triggering states. For example, process 600 may include receiving a QCL configuration that associates one or more TCI states with a QCL type D; receiving a PDCCH communication carrying DCI associated with one or more aperiodic UE-to-UE CLI measurement resources corresponding to the one or more TCI states; receiving one or more CLI measurement signals in accordance with a UE behavior that the UE 120 may not expect to be configured with a scheduling offset between a last symbol of the PDCCH communication carrying the DCI and a first symbol of the one or more aperiodic UE-to-UE CLI measurement resources that does not satisfy (for example, is smaller than) a UE-reported beam switch timing threshold; and transmitting an aperiodic CLI report in accordance with the one or more CLI measurement signals.

In a third additional aspect, alone or in combination with one or more of the first and second aspects, receiving the one or more CLI measurement signals includes receiving the one or more CLI measurement signals using default beam in accordance with the scheduling offset not satisfying the UE-reported beam switch timing threshold.

In a fourth additional aspect, alone or in combination with one or more of the first through third aspects, the default beam is identified using a rule.

In a fifth additional aspect, alone or in combination with one or more of the first through fourth aspects, the default beam is, in accordance with the rule, a latest beam associated with a latest-received PDSCH reception or a latest-monitored CORESET in accordance with no unified TCI state type being configured.

In a sixth additional aspect, alone or in combination with one or more of the first through fifth aspects, the default beam is, in accordance with the rule, associated with an indicated downlink-only or joint TCI state in accordance with a unified TCI state type being configured.

In a seventh additional aspect, alone or in combination with one or more of the first through sixth aspects, the default beam is, in accordance with the rule, associated with a QCL assumption of a downlink signal scheduled in the one or more aperiodic UE-to-UE CLI measurement resources, the downlink signal is a PDSCH communication scheduled with a scheduling offset that satisfies a QCL time duration threshold, a periodic CSI-RS, a semi-persistent CSI-RS, an aperiodic CSI-RS in a non-zero-power CSI-RS resource set, a periodic CLI SRS-RSRP or CLI-RSSI, a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold.

In an eighth additional aspect, alone or in combination with one or more of the first through seventh aspects, the default beam is, in accordance with the rule, associated with a QCL assumption of a CORESET associated with a monitored search space with a lowest CORESET identifier in a latest slot in which the UE monitors one or more CORESETs within an active BWP of a serving cell of the UE in accordance with the UE not receiving an indication of a downlink or joint TCI state list and in accordance with the one or more CORESETs being configured for a BWP of the one or more CLI measurement signals.

In a ninth additional aspect, alone or in combination with one or more of the first through eighth aspects, the default beam is, in accordance with the rule, associated with a QCL assumption of a CORESET associated with a monitored search space with a lowest CORESET identifier in a latest slot in which the UE monitors one or more CORESETs within an active BWP of a serving cell of the UE in accordance with the UE receiving an indication of a downlink or joint TCI state list, in accordance with an indicated TCI state being associated with a physical cell identifier that does not correspond to the serving cell, and in accordance with the one or more CORESETs being configured for a BWP of the one or more CLI measurement signals.

In a tenth additional aspect, alone or in combination with one or more of the first through ninth aspects, the UE is associated with carrier aggregation, and the default beam is, in accordance with the rule, associated with a QCL type D assumption of a CLI signal in a CC with a lowest CC identifier of CC identifiers of the one or more CLI measurement signals in a frequency band in accordance with the one or more CLI measurement signals having different QCL assumptions and respective CCs in a slot.

In an eleventh additional aspect, alone or in combination with one or more of the first through tenth aspects, the default beam is, in accordance with the rule, associated with an indicated TCI state in accordance with the UE receiving an indication of a downlink or joint TCI state list and in accordance with the indicated TCI state being associated with a PCI of a serving cell of the UE.

In a twelfth additional aspect, alone or in combination with one or more of the first through eleventh aspects, the UE is associated with an mTRP architecture.

In a thirteenth additional aspect, alone or in combination with one or more of the first through twelfth aspects, default TCI states corresponding to respective CORESET pool indexes are enabled and the respective CORESET pool indexes are associated with respective transmission reception points of the mTRP architecture and are configured with respective values in a CORESET.

In a fourteenth additional aspect, alone or in combination with one or more of the first through thirteenth aspects, the default beam is, in accordance with the rule, associated with a QCL assumption of a downlink signal with an indicated TCI state in a same symbol as the one or more CLI measurement signals, the downlink signal is a PDSCH communication scheduled by a PDCCH communication associated with a same CORESET pool index as the PDCCH communication carrying the DCI and having a scheduling offset that satisfies a QCL time duration threshold, or the downlink signal is an aperiodic CLI SRS-RSRP or CLI-RSSI triggered by a PDCCH communication associated with a same CORESET pool index as the PDCCH communication carrying the DCI and having a scheduling offset that satisfies the UE-reported beam switch timing threshold and a reported value is 14, 28, or 48.

In a fifteenth additional aspect, alone or in combination with one or more of the first through fourteenth aspects, the default beam is, in accordance with the rule, associated with one or more QCL parameters of a CORESET associated with a monitored search space with a lowest CORESET identifier among CORESETs configured with a same CORESET pool index value as the PDCCH communication in a latest slot in which the UE monitors one or more CORESETs associated with the same CORESET pool index as the PDCCH communication in accordance with a downlink communication not having an indicated TCI state in a same symbol as the one or more CLI measurement signals.

In a sixteenth additional aspect, alone or in combination with one or more of the first through fifteenth aspects, multiple default TCI states are enabled and at least one TCI codepoint is mapped to the multiple default TCI states.

In a seventeenth additional aspect, alone or in combination with one or more of the first through sixteenth aspects, the default beam is, in accordance with the rule, associated with a QCL assumption of a downlink signal with an indicated TCI state in a same symbol as the one or more CLI measurement signals, the downlink signal is a PDSCH communication scheduled with a scheduling offset that satisfies a QCL time duration threshold, or the downlink signal is an aperiodic CLI SRS-RSRP or CLI-RSSI scheduled with a scheduling offset that satisfies the UE-reported beam switch timing threshold and a reported value is 14, 28, or 48.

In an eighteenth additional aspect, alone or in combination with one or more of the first through seventeenth aspects, the default beam is, in accordance with the rule, associated with a first TCI state of the multiple default TCI states that corresponds to a lowest TCI codepoint of the at least one TCI codepoint and that is associated with a PDSCH within an active BWP of a cell in which the one or more CLI measurement signals are scheduled in accordance with a downlink communication not having an indicated TCI state in a same symbol as the one or more CLI measurement signals.

In a nineteenth additional aspect, alone or in combination with one or more of the first through eighteenth aspects, an SFN PDCCH scheme A or an SFN scheme B is configured, multiple default TCI states are not configured, and multiple TCI states associated with a CORESET are activated using an activation command.

In a twentieth additional aspect, alone or in combination with one or more of the first through nineteenth aspects, the default beam is, in accordance with the rule, associated with a QCL assumption of a downlink signal with an indicated TCI state in a same symbol as the one or more CLI measurement signals, the downlink signal is a PDSCH communication scheduled with a scheduling offset that satisfies a QCL time duration threshold, a periodic CSI-RS, a semi-persistent CSI-RS, an aperiodic CSI-RS in a non-zero-power CSI-RS resource set, a periodic CLI SRS-RSRP or CLI-RSSI, a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold and a reported value is 14, 28, or 48.

In a twenty-first additional aspect, alone or in combination with one or more of the first through twentieth aspects, the default beam is, in accordance with the rule, associated with a first TCI state associated with a CORESET corresponding to a lowest CORESET identifier in a latest slot within an active BWP of a cell in which the one or more CLI measurement signals are received in accordance with multiple TCI states being activated for the CORESET.

In a twenty-second additional aspect, alone or in combination with one or more of the first through twenty-first aspects, the default beam is, in accordance with the rule, associated with a single activated TCI state of a CORESET corresponding to a lowest CORESET identifier in a latest slot within an active bandwidth part of a cell in which the one or more CLI measurement signals are received in accordance with multiple TCI states not being activated for the CORESET.

In a twenty-third additional aspect, alone or in combination with one or more of the first through twenty-second aspects, receiving the QCL configuration comprises receiving a QCL configuration for each aperiodic UE-to-UE CLI measurement resource in a UE-to-UE CLI measurement resource set associated with one or more triggering states, the QCL configuration configures one or more QCL reference signal sources and QCL type D via QCL higher-layer signaling of QCL information that includes one or more TCI states corresponding to each aperiodic UE-to-UE CLI measurement resource, a TCI state of the one or more TCI states corresponding to each aperiodic UE-to-UE CLI measurement resource is configured with a reference to a QCL reference signal configured with a QCL type set to QCL type D, and the QCL reference signal is an SS/PBCH or a periodic or semi-persistent UE-to-UE CLI measurement resource.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports CLI measurements with QCL type D. The apparatus 700 may be a UE, or a UE may include the apparatus 700. In some aspects, the apparatus 700 includes a reception component 702, a transmission component 704, and a communication manager 706, which may be in communication with one another (for example, via one or more buses). As shown, the apparatus 700 may communicate with another apparatus 708 (such as a UE 120, a network node 110, or another wireless communication device) using the reception component 702 and the transmission component 704. The communication manager 706 may be included in, or implemented via, a processing system (for example, the processing system 140). In some aspects, the communication manager 706 is the communication manager 150.

In some aspects, the apparatus 700 may be configured to or operable to perform one or more operations described herein in connection with FIG. 5. Additionally or alternatively, the apparatus 700 may be configured to or operable to perform one or more processes described herein, such as process 600 of FIG. 6.

The reception component 702 may receive communications, such as reference signals, control information, or data communications, from the apparatus 708. The reception component 702 may provide received communications to one or more other components of the apparatus 700, such as the communication manager 706. In some aspects, the reception component 702 may perform signal processing on the received communications, and may provide the processed signals to the one or more other components in a similar manner as described above in connection with FIG. 1. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, or data communications, to the apparatus 708. In some aspects, the communication manager 706 may generate communications and may transmit the generated communications to the transmission component 704 for transmission to the apparatus 708. In some aspects, the transmission component 704 may perform signal processing on the generated communications, and may transmit the processed signals to the apparatus 708 in a similar manner as described above in connection with FIG. 1. In some aspects, the transmission component 704 may include one or more components of the UE described above in connection with FIG. 1, such as a radio, one or more RF chains, one or more transceivers, or one or more modems, each of which may in turn be coupled with one or more antennas of the UE. In some aspects, the transmission component 704 may be co-located with the reception component 702.

The communication manager 706 may receive or may cause the reception component 702 to receive a QCL configuration that associates one or more TCI states with a QCL type D. The communication manager 706 may receive or may cause the reception component 702 to receive a PDCCH communication carrying DCI associated with one or more aperiodic UE-to-UE CLI measurement resources corresponding to the one or more TCI states. The communication manager 706 may receive or may cause the reception component 702 to receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold. The communication manager 706 may transmit or may cause the transmission component 704 to transmit an aperiodic CLI report in accordance with the one or more CLI measurement signals. In some aspects, the communication manager 706 may perform one or more operations described elsewhere herein as being performed by one or more components of the communication manager 706.

The reception component 702 may receive a QCL configuration that associates one or more TCI states with a QCL type D. The reception component 702 may receive a PDCCH communication carrying DCI associated with one or more aperiodic UE-to-UE CLI measurement resources corresponding to the one or more TCI states. The reception component 702 may receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold. The transmission component 704 may transmit an aperiodic CLI report in accordance with the one or more CLI measurement signals.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed at a user equipment (UE), comprising: receiving a quasi-co-location (QCL) configuration that associates one or more transmission configuration indicator (TCI) states with a QCL type D; receiving a physical downlink control channel (PDCCH) communication carrying downlink control information (DCI) associated with one or more aperiodic UE-to-UE cross-link interference (CLI) measurement resources corresponding to the one or more TCI states; receiving one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold; and transmitting an aperiodic CLI report in accordance with the one or more CLI measurement signals.

Aspect 2: The method of Aspect 1, wherein the one or more aperiodic UE-to-UE CLI measurement resources include one or more aperiodic UE-to-UE CLI sounding reference signal reference signal received power (SRS-RSRP) measurement resources or CLI received signal strength indicator (CLI-RSSI) measurement resources.

Aspect 3: The method of any of Aspects 1-2, wherein receiving the one or more CLI measurement signals includes receiving the one or more CLI measurement signals using a default beam in accordance with the scheduling offset satisfying the UE-reported beam switch timing threshold, wherein the default beam is configured per aperiodic UE-to-UE CLI measurement resource of the one or more aperiodic UE-to-UE CLI measurement resources, and wherein the one or more aperiodic UE-to-UE CLI measurement resources are associated with one or more triggering states.

Aspect 4: The method of any of Aspects 1-3, wherein receiving the one or more CLI measurement signals includes receiving the one or more CLI measurement signals using a default beam in accordance with the scheduling offset not satisfying the UE-reported beam switch timing threshold.

Aspect 5: The method of Aspect 4, wherein the default beam is identified using a rule.

Aspect 6: The method of Aspect 5, wherein the default beam is, in accordance with the rule, a latest beam associated with a latest-received physical downlink shared channel (PDSCH) reception or a latest-monitored control resource set (CORESET) in accordance with no unified TCI state type being configured.

Aspect 7: The method of Aspect 5, wherein the default beam is, in accordance with the rule, associated with an indicated downlink-only or joint TCI state in accordance with a unified TCI state type being configured.

Aspect 8: The method of Aspect 5, wherein the default beam is, in accordance with the rule, associated with a QCL assumption of a downlink signal scheduled in the one or more aperiodic UE-to-UE CLI measurement resources, wherein the downlink signal is a physical downlink shared channel (PDSCH) communication scheduled with a scheduling offset that satisfies a QCL time duration threshold, a periodic channel state information reference signal (CSI-RS), a semi-persistent CSI-RS, an aperiodic CSI-RS in a non-zero-power CSI-RS resource set, a periodic CLI sounding reference signal reference signal received power (SRS-RSRP) or CLI received signal strength indicator (CLI-RSSI), a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold.

Aspect 9: The method of Aspect 5, wherein the default beam is, in accordance with the rule, associated with a QCL assumption of a control resource set (CORESET) associated with a monitored search space with a lowest CORESET identifier in a latest slot in which the UE monitors one or more CORESETs within an active bandwidth part (BWP) of a serving cell of the UE in accordance with the UE not receiving an indication of a downlink or joint TCI state list and in accordance with the one or more CORESETs being configured for a BWP of the one or more CLI measurement signals.

Aspect 10: The method of Aspect 5, wherein the default beam is, in accordance with the rule, associated with a QCL assumption of a control resource set (CORESET) associated with a monitored search space with a lowest CORESET identifier in a latest slot in which the UE monitors one or more CORESETs within an active bandwidth part (BWP) of a serving cell of the UE in accordance with the UE receiving an indication of a downlink or joint TCI state list, in accordance with an indicated TCI state being associated with a physical cell identifier that does not correspond to the serving cell, and in accordance with the one or more CORESETs being configured for a BWP of the one or more CLI measurement signals.

Aspect 11: The method of Aspect 5, wherein the UE is associated with carrier aggregation, and the default beam is, in accordance with the rule, associated with a QCL type D assumption of a CLI signal in a component carrier (CC) with a lowest CC identifier of CC identifiers of the one or more CLI measurement signals in a frequency band in accordance with the one or more CLI measurement signals having different QCL assumptions and respective CCs in a slot.

Aspect 12: The method of Aspect 5, wherein the default beam is, in accordance with the rule, associated with an indicated TCI state in accordance with the UE receiving an indication of a downlink or joint TCI state list and in accordance with the indicated TCI state being associated with a physical cell identifier of a serving cell of the UE.

Aspect 13: The method of Aspect 5, wherein the UE is associated with a multiple transmission reception point (mTRP) architecture.

Aspect 14: The method of Aspect 13, wherein default TCI states corresponding to respective control resource set (CORESET) pool indexes are enabled and the respective CORESET pool indexes are associated with respective transmission reception points of the mTRP architecture and are configured with respective values in a CORESET.

Aspect 15: The method of Aspect 14, wherein the default beam is, in accordance with the rule, associated with a QCL assumption of a downlink signal with an indicated TCI state in a same symbol as the one or more CLI measurement signals, wherein the downlink signal is a physical downlink shared channel (PDSCH) communication scheduled by a PDCCH communication associated with a same CORESET pool index as the PDCCH communication carrying the DCI and having a scheduling offset that satisfies a QCL time duration threshold, or wherein the downlink signal is an aperiodic CLI SRS-RSRP or CLI-RSSI triggered by a PDCCH communication associated with a same CORESET pool index as the PDCCH communication carrying the DCI and having a scheduling offset that satisfies the UE-reported beam switch timing threshold and a reported value is 14, 28, or 48.

Aspect 16: The method of Aspect 14, wherein the default beam is, in accordance with the rule, associated with one or more QCL parameters of a control resource set (CORESET) associated with a monitored search space with a lowest CORESET identifier among CORESETs configured with a same CORESET pool index value as the PDCCH communication in a latest slot in which the UE monitors one or more CORESETs associated with the same CORESET pool index as the PDCCH communication in accordance with a downlink communication not having an indicated TCI state in a same symbol as the one or more CLI measurement signals.

Aspect 17: The method of Aspect 13, wherein multiple default TCI states are enabled and at least one TCI codepoint is mapped to the multiple default TCI states.

Aspect 18: The method of Aspect 17, wherein the default beam is, in accordance with the rule, associated with a QCL assumption of a downlink signal with an indicated TCI state in a same symbol as the one or more CLI measurement signals, wherein the downlink signal is a physical downlink shared channel (PDSCH) communication scheduled with a scheduling offset that satisfies a QCL time duration threshold, or wherein the downlink signal is an aperiodic CLI SRS-RSRP or CLI-RSSI scheduled with a scheduling offset that satisfies the UE-reported beam switch timing threshold and a reported value is 14, 28, or 48.

Aspect 19: The method of Aspect 17, wherein the default beam is, in accordance with the rule, associated with a first TCI state of the multiple default TCI states that corresponds to a lowest TCI codepoint of the at least one TCI codepoint and that is associated with a physical downlink shared channel (PDSCH) within an active bandwidth part (BWP) of a cell in which the one or more CLI measurement signals are scheduled in accordance with a downlink communication not having an indicated TCI state in a same symbol as the one or more CLI measurement signals.

Aspect 20: The method of Aspect 13, wherein a single-frequency network (SFN) PDCCH scheme A or an SFN scheme B is configured, multiple default TCI states are not configured, and multiple TCI states associated with a control resource set (CORESET) are activated using an activation command.

Aspect 21: The method of Aspect 20, wherein the default beam is, in accordance with the rule, associated with a QCL assumption of a downlink signal with an indicated TCI state in a same symbol as the one or more CLI measurement signals, wherein the downlink signal is a physical downlink shared channel (PDSCH) communication scheduled with a scheduling offset that satisfies a QCL time duration threshold, a periodic channel state information reference signal (CSI-RS), a semi-persistent CSI-RS, an aperiodic CSI-RS in a non-zero-power CSI-RS resource set, a periodic CLI sounding reference signal reference signal received power (SRS-RSRP) or CLI received signal strength indicator (CLI-RSSI), a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold and wherein a reported value is 14, 28, or 48.

Aspect 22: The method of Aspect 21, wherein the default beam is, in accordance with the rule, associated with a first TCI state associated with a CORESET corresponding to a lowest CORESET identifier in a latest slot within an active bandwidth part (BWP) of a cell in which the one or more CLI measurement signals are received in accordance with multiple TCI states being activated for the CORESET.

Aspect 23: The method of Aspect 21, wherein the default beam is, in accordance with the rule, associated with a single activated TCI state of a CORESET corresponding to a lowest CORESET identifier in a latest slot within an active bandwidth part of a cell in which the one or more CLI measurement signals are received in accordance with multiple TCI states not being activated for the CORESET.

Aspect 24: The method of any of Aspects 1-23, wherein receiving the QCL configuration comprises receiving a QCL configuration for each aperiodic UE-to-UE CLI measurement resource in a UE-to-UE CLI measurement resource set associated with one or more triggering states, the QCL configuration configures one or more QCL reference signal sources and QCL type D via QCL higher-layer signaling of QCL information that includes one or more TCI states corresponding to each aperiodic UE-to-UE CLI measurement resource, a TCI state of the one or more TCI states corresponding to each aperiodic UE-to-UE CLI measurement resource is configured with a reference to a QCL reference signal configured with a QCL type set to QCL type D, and the QCL reference signal is a synchronization signal or physical broadcast channel (SS/PBCH) block or a periodic or semi-persistent UE-to-UE CLI measurement resource.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

Aspect 32: A device comprising a processing system that includes one or more processors and one or more code-storing memories coupled with the one or more processors, the processing system configured to cause the device to perform the method of one or more of Aspects 1-24.

Aspect 33: A device comprising a processing system that includes processor circuitry and code-storing memory circuitry, the processing system configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a quasi-co-location (QCL) configuration that associates one or more transmission configuration indicator (TCI) states with a QCL type D;
receive a physical downlink control channel (PDCCH) communication carrying downlink control information (DCI) associated with one or more aperiodic UE-to-UE cross-link interference (CLI) measurement resources corresponding to the one or more TCI states;
receive one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold; and
transmit an aperiodic CLI report in accordance with the one or more CLI measurement signals.

2. The apparatus of claim 1, wherein the at least one processor configured to cause the UE to receive the one or more CLI measurement signals is configured to cause the UE to receive the one or more CLI measurement signals using a default beam in accordance with the scheduling offset not satisfying the UE-reported beam switch timing threshold, and wherein the default beam is identified using a rule.

3. The apparatus of claim 2, wherein the default beam is, in accordance with the rule, a latest beam associated with a latest-received physical downlink shared channel (PDSCH) reception or a latest-monitored control resource set (CORESET) in accordance with no unified TCI state type being configured.

4. The apparatus of claim 2, wherein the default beam is, in accordance with the rule, associated with an indicated downlink-only or joint TCI state in accordance with a unified TCI state type being configured.

5. The apparatus of claim 2, wherein the default beam is, in accordance with the rule, associated with a QCL assumption of a downlink signal scheduled in the one or more aperiodic UE-to-UE CLI measurement resources, wherein the downlink signal is a physical downlink shared channel (PDSCH) communication scheduled with a scheduling offset that satisfies a QCL time duration threshold, a periodic channel state information reference signal (CSI-RS), a semi-persistent CSI-RS, an aperiodic CSI-RS in a non-zero-power CSI-RS resource set, a periodic CLI sounding reference signal reference signal received power (SRS-RSRP) or CLI received signal strength indicator (CLI-RSSI), a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold.

6. The apparatus of claim 2, wherein the default beam is, in accordance with the rule, associated with a QCL assumption of a control resource set (CORESET) associated with a monitored search space with a lowest CORESET identifier in a latest slot in which the UE monitors one or more CORESETs within an active bandwidth part (BWP) of a serving cell of the UE in accordance with the UE not receiving an indication of a downlink or joint TCI state list and in accordance with the one or more CORESETs being configured for a BWP of the one or more CLI measurement signals.

7. The apparatus of claim 2, wherein the default beam is, in accordance with the rule, associated with a QCL assumption of a control resource set (CORESET) associated with a monitored search space with a lowest CORESET identifier in a latest slot in which the UE monitors one or more CORESETs within an active bandwidth part (BWP) of a serving cell of the UE in accordance with the UE receiving an indication of a downlink or joint TCI state list, in accordance with an indicated TCI state being associated with a physical cell identifier that does not correspond to the serving cell, and in accordance with the one or more CORESETs being configured for a BWP of the one or more CLI measurement signals.

8. The apparatus of claim 2, wherein the UE is associated with carrier aggregation, and the default beam is, in accordance with the rule, associated with a QCL type D assumption of a CLI signal in a component carrier (CC) with a lowest CC identifier of CC identifiers of the one or more CLI measurement signals in a frequency band in accordance with the one or more CLI measurement signals having different QCL assumptions and respective CCs in a slot.

9. The apparatus of claim 2, wherein the default beam is, in accordance with the rule, associated with an indicated TCI state in accordance with the UE receiving an indication of a downlink or joint TCI state list and in accordance with the indicated TCI state being associated with a physical cell identifier of a serving cell of the UE.

10. The apparatus of claim 2, wherein the UE is associated with a multiple transmission reception point (mTRP) architecture, wherein default TCI states corresponding to respective control resource set (CORESET) pool indexes are enabled and the respective CORESET pool indexes are associated with respective transmission reception points of the mTRP architecture and are configured with respective values in a CORESET, and wherein the default beam is, in accordance with the rule, associated with a QCL assumption of a downlink signal with an indicated TCI state in a same symbol as the one or more CLI measurement signals, wherein the downlink signal is a physical downlink shared channel (PDSCH) communication scheduled by a PDCCH communication associated with a same CORESET pool index as the PDCCH communication carrying the DCI and having a scheduling offset that satisfies a QCL time duration threshold, or wherein the downlink signal is an aperiodic CLI SRS-RSRP or CLI-RSSI triggered by a PDCCH communication associated with a same CORESET pool index as the PDCCH communication carrying the DCI and having a scheduling offset that satisfies the UE-reported beam switch timing threshold and a reported value is 14, 28, or 48.

11. The apparatus of claim 2, wherein the UE is associated with a multiple transmission reception point (mTRP) architecture, wherein default TCI states corresponding to respective control resource set (CORESET) pool indexes are enabled and the respective CORESET pool indexes are associated with respective transmission reception points of the mTRP architecture and are configured with respective values in a CORESET, and wherein the default beam is, in accordance with the rule, associated with one or more QCL parameters of a control resource set (CORESET) associated with a monitored search space with a lowest CORESET identifier among CORESETs configured with a same CORESET pool index value as the PDCCH communication in a latest slot in which the UE monitors one or more CORESETs associated with the same CORESET pool index as the PDCCH communication in accordance with a downlink communication not having an indicated TCI state in a same symbol as the one or more CLI measurement signals.

12. The apparatus of claim 2, wherein the UE is associated with a multiple transmission reception point (mTRP) architecture, wherein multiple default TCI states are enabled and at least one TCI codepoint is mapped to the multiple default TCI states and, wherein the default beam is, in accordance with the rule, associated with a QCL assumption of a downlink signal with an indicated TCI state in a same symbol as the one or more CLI measurement signals, wherein the downlink signal is a physical downlink shared channel (PDSCH) communication scheduled with a scheduling offset that satisfies a QCL time duration threshold, or wherein the downlink signal is an aperiodic CLI SRS-RSRP or CLI-RSSI scheduled with a scheduling offset that satisfies the UE-reported beam switch timing threshold and a reported value is 14, 28, or 48.

13. The apparatus of claim 2, wherein the UE is associated with a multiple transmission reception point (mTRP) architecture, wherein multiple default TCI states are enabled and at least one TCI codepoint is mapped to the multiple default TCI states, and wherein the default beam is, in accordance with the rule, associated with a first TCI state of the multiple default TCI states that corresponds to a lowest TCI codepoint of the at least one TCI codepoint and that is associated with a physical downlink shared channel (PDSCH) within an active bandwidth part (BWP) of a cell in which the one or more CLI measurement signals are scheduled in accordance with a downlink communication not having an indicated TCI state in a same symbol as the one or more CLI measurement signals.

14. The apparatus of claim 2, wherein the UE is associated with a multiple transmission reception point (mTRP) architecture, wherein a single-frequency network (SFN) PDCCH scheme A or an SFN scheme B is configured, multiple default TCI states are not configured, and multiple TCI states associated with a control resource set (CORESET) are activated using an activation command, wherein the default beam is, in accordance with the rule, associated with a QCL assumption of a downlink signal with an indicated TCI state in a same symbol as the one or more CLI measurement signals, wherein the downlink signal is a physical downlink shared channel (PDSCH) communication scheduled with a scheduling offset that satisfies a QCL time duration threshold, a periodic channel state information reference signal (CSI-RS), a semi-persistent CSI-RS, an aperiodic CSI-RS in a non-zero-power CSI-RS resource set, a periodic CLI sounding reference signal reference signal received power (SRS-RSRP) or CLI received signal strength indicator (CLI-RSSI), a semi-persistent CLI SRS-RSRP or CLI-RSSI, or an aperiodic CLI SRS-RSRP or CLI-RSSI in a CLI SRS-RSRP or CLI-RSSI resource set scheduled with a scheduling offset that satisfies the UE-reported beam switch timing threshold and wherein a reported value is 14, 28, or 48.

15. The apparatus of claim 14, wherein the default beam is, in accordance with the rule, associated with a first TCI state associated with a CORESET corresponding to a lowest CORESET identifier in a latest slot within an active bandwidth part (BWP) of a cell in which the one or more CLI measurement signals are received in accordance with multiple TCI states being activated for the CORESET, or wherein the default beam is, in accordance with the rule, associated with a single activated TCI state of the CORESET in accordance with the multiple TCI states not being activated for the CORESET.

16. A method of wireless communication performed at a user equipment (UE), comprising:
receiving a quasi-co-location (QCL) configuration that associates one or more transmission configuration indicator (TCI) states with a QCL type D;
receiving a physical downlink control channel (PDCCH) communication carrying downlink control information (DCI) associated with one or more aperiodic UE-to-UE cross-link interference (CLI) measurement resources corresponding to the one or more TCI states;
receiving one or more CLI measurement signals in accordance with a scheduling offset between a last symbol of the PDCCH communication carrying the DCI and a first symbol of the one or more aperiodic UE-to-UE CLI measurement resources satisfying, or not satisfying, a UE-reported beam switch timing threshold; and
transmitting an aperiodic CLI report in accordance with the one or more CLI measurement signals.

17. The method of claim 16, wherein the one or more aperiodic UE-to-UE CLI measurement resources include one or more aperiodic UE-to-UE CLI sounding reference signal reference signal received power (SRS-RSRP) measurement resources or CLI received signal strength indicator (CLI-RSSI) measurement resources.

18. The method of claim 16, wherein receiving the one or more CLI measurement signals includes receiving the one or more CLI measurement signals using a default beam in accordance with the scheduling offset satisfying the UE-reported beam switch timing threshold, wherein the default beam is configured per aperiodic UE-to-UE CLI measurement resource of the one or more aperiodic UE-to-UE CLI measurement resources, and wherein the one or more aperiodic UE-to-UE CLI measurement resources are associated with one or more triggering states.

19. The method of claim 16, wherein receiving the QCL configuration comprises receiving a QCL configuration for each aperiodic UE-to-UE CLI measurement resource in a UE-to-UE CLI measurement resource set associated with one or more triggering states, the QCL configuration configures one or more QCL reference signal sources and QCL type D via QCL higher-layer signaling of QCL information that includes one or more TCI states corresponding to each aperiodic UE-to-UE CLI measurement resource, a TCI state of the one or more TCI states corresponding to each aperiodic UE-to-UE CLI measurement resource is configured with a reference to a QCL reference signal configured with a QCL type set to QCL type D, and the QCL reference signal is a synchronization signal or physical broadcast channel (SS/PBCH) block or a periodic or semi-persistent UE-to-UE CLI measurement resource.

20. An apparatus for wireless communication, comprising:
means for receiving a quasi-co-location (QCL) configuration that associates one or more transmission configuration indicator (TCI) states with a QCL type D;
means for receiving a physical downlink control channel (PDCCH) communication carrying downlink control information (DCI) associated with one or more aperiodic apparatus-to-apparatus cross-link interference (CLI) measurement resources corresponding to the one or more TCI states;
means for receiving one or more CLI measurement signals in accordance with a scheduling offset between a last symbol of the PDCCH communication carrying the DCI and a first symbol of the one or more aperiodic apparatus-to-apparatus CLI measurement resources satisfying, or not satisfying, an apparatus-reported beam switch timing threshold; and
means for transmitting an aperiodic CLI report in accordance with the one or more CLI measurement signals.
